(19) United States
(12) Patent Application Publication
(10) Pub. No.: US 2016/0269445 A1
(43) Pub. Date: Sep. 15, 2016

(54) CLOUD-BASED NETWORK SECURITY AND ACCESS CONTROL

(71) Applicant: Verite Group, Inc., Dulles, VA (US)

(72) Inventors: George O. Dotterer, III, Sterling, VA (US); David A. Hedges, Arlington, VA (US); Scott T. Kelly, Laytonsville, MD (US); David G. Maschinsky, Washington, DC (US); Nathan H. Robinson, Dulles, VA (US)

(73) Assignee: Verite Group, Inc., Dulles, VA (US)

(21) Appl. No.: 15/159,709

(22) Filed: May 19, 2016

Related U.S. Application Data
(63) Continuation of application No. 14/640,222, filed on Mar. 6, 2015.
(60) Provisional application No. 61/949,716, filed on Mar. 7, 2014.

(51) Int. Cl. H04L 29/06; H04L 29/12; H04L 12/58; H04W 12/08; H04W 76/02; H04L 29/08; H04L 12/927

(52) U.S. Cl. CPC H04L 63/20; H04L 67/10; H04L 67/02; H04L 69/16; H04L 61/2521; H04L 47/803; H04W 12/08; H04W 76/022; H04L 51/26; H04L 63/10; H04W 88/02

(57) ABSTRACT

Technologies are presented that provide cloud-based network security and access control in a networked computing system. A method may include: receiving a network traffic request from a user device, identifying the user device, applying rules specific to the network traffic request and the user device, obtaining data specific to the network traffic request in accordance with the applied rules, and providing the data to the user device for presentation to a user in accordance with the applied rules. Applying rules may include blocking, capturing, processing, redirecting, reporting on, and/or alerting to, network traffic related to the user device. The method may also include monitoring network traffic to and from the user device, and generating reports regarding the monitored network traffic. The method may further include detecting a rule violation, and providing a rule violation alert regarding the rule violation to one or more designated alert recipient devices.

### CROSS-REFERENCE TO RELATED APPLICATIONS

This application is a continuation of U.S. Utility patent application Ser. No. 14/640,222, filed Mar. 3, 2015, which claims the benefit of U.S. Provisional Patent Application No. 61/949,716, filed Mar. 7, 2014, each of which is hereby incorporated by reference in its entirety.

### TECHNICAL FIELD

The technologies described herein generally relate to information access in a networked computing system.

### BACKGROUND

Currently, network security and access control may include, for example, preventing and monitoring unauthorized access, misuse, modification, and denial of a computer network and network accessible resources. Network security and access control is a high-dollar industry with many competitors and solutions available. Many of today's solutions are built upon, and mostly focus on, installing software on computers (e.g., desktop computers, laptops, etc.). These solutions have not been able to easily extend the same security implementations to other network (e.g., Internet) connected devices such as mobile phones, tablets, etc.

Many current solutions are software-based and involve securing data at the point of the user device. As an example, for a known antivirus software program to work, it must be installed on a device, and its software monitors traffic entering and leaving the network interface of that device. This approach may not be feasible for some contemporary devices that may be used to access a network (e.g., the Internet), such as mobile phones, tablets, etc. For example, some network devices may not be capable of running the same software as other computing devices such as desktop computers and laptops. Although these network devices may run operating systems, they are typically less expandable than most desktop computers, laptop computers, etc. Therefore, these network devices may not meet the minimum requirements of today's security software.

In addition, devices with multiple network interfaces are more prevalent today. Mobile devices like smart phones may allow users to access a network (e.g., the Internet) multiple ways (e.g., via a cellular network (e.g., 2G, 3G, 4G, 4G/LTE, etc.), WiMax, Wi-Fi, etc.). The burden of supporting the various network interfaces introduces complexities that software solutions alone may not be able to handle. Furthermore, there are currently many types of network connected devices running different operating systems. Network security software that works with one operating system may not work with another operating system. Therefore, to provide a software solution for every computing device may require many entirely different software solutions. This is further complicated when considering devices beyond traditional computing devices, such as mobile phones, tablets, etc.

Moreover, different devices may require adherence to different policies and software restrictions. For example, a tablet running its own operating system may not be able to access information related to other applications installed or running on the tablet. For example, an operating system may restrict some applications from communicating with other applications to prevent data sharing between the applications. Without modifying the device, such as rooting or “jail breaking,” it may be impossible for a traditional network security model to work. Thus, different device policies may require multiple software solutions, with varying success, in a traditional computer security model.

### BRIEF DESCRIPTION OF THE DRAWINGS / FIGURES

FIG. 1 is a block diagram of an example known communication system to access a network, such as the Internet.

FIG. 2 is a block diagram of an example network security and access control system, according to an embodiment.

FIG. 3 is a more detailed block diagram of an example network security and access control system, according to an embodiment.

FIGS. 4 and 5 are sequence diagrams showing functionality of an example network security and access control system, according to embodiments.

FIG. 6 is a block diagram of an example network security and access control server, according to an embodiment.

FIG. 7 is a block diagram of an example user device, according to an embodiment.

FIG. 8 is an example mobile information device in which an embodiment may be implemented.

In the drawings, the leftmost digit(s) of a reference number may identify the drawing in which the reference number first appears.

### DETAILED DESCRIPTION

In the embodiments presented herein, a cloud-based network security and access control service is described. Using this service, security may be moved away from individual user devices and on to one or more centralized devices, or servers. The centralized devices, or servers, may apply rules to, for example, alert on, block, capture, process, redirect (e.g., if website X is requested, website Y is obtained), and/or report on a connected user device's incoming and outgoing network traffic. Other features, such as reporting on application status, tampering, mobile phone usage, etc., may also be implemented. These features may be implemented at either the user device or the centralized devices or servers.

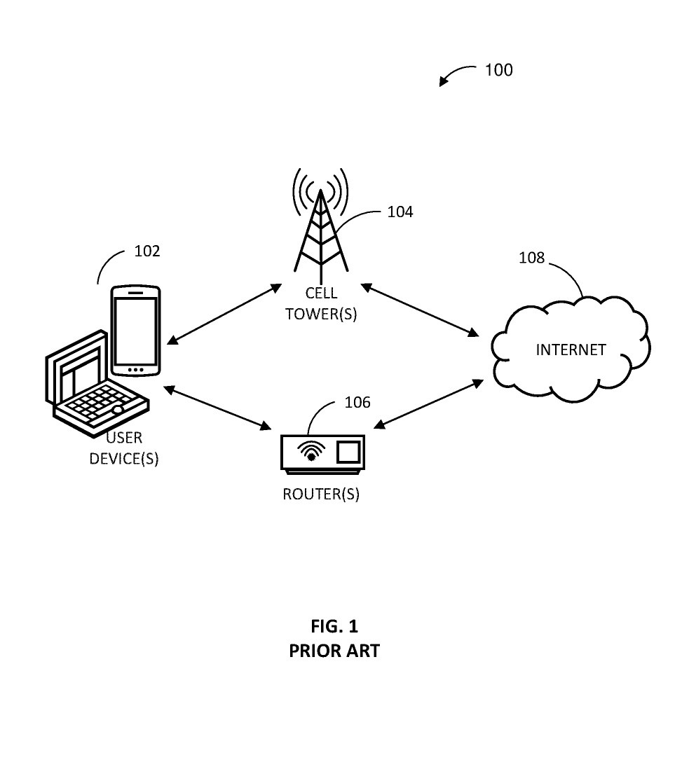

FIG. 1 depicts a typical communication system 100 in which user devices, including both non-mobile and mobile or handheld devices, may communicate with other devices over one or more networks, such as the Internet. In FIG. 1, user devices 102 may communicate with devices on the Internet 108 using cellular telecommunication technology (e.g., 3G, 4G, 4G/LTE, etc.) via one or more cell towers 104, for example. User devices 102 may also communicate with the Internet 108 through other communication devices such as one or more wired or wireless routers 106 (e.g., via Wi-Fi technology). As discussed above, due to the complexity of issues for providing a software solution for network security / access control for contemporary devices (e.g., mobile devices), taking the same approach as taken by a traditional computer security model may not be feasible, sustainable, or applicable. A different approach, one not solely based upon software at the user device, is needed.

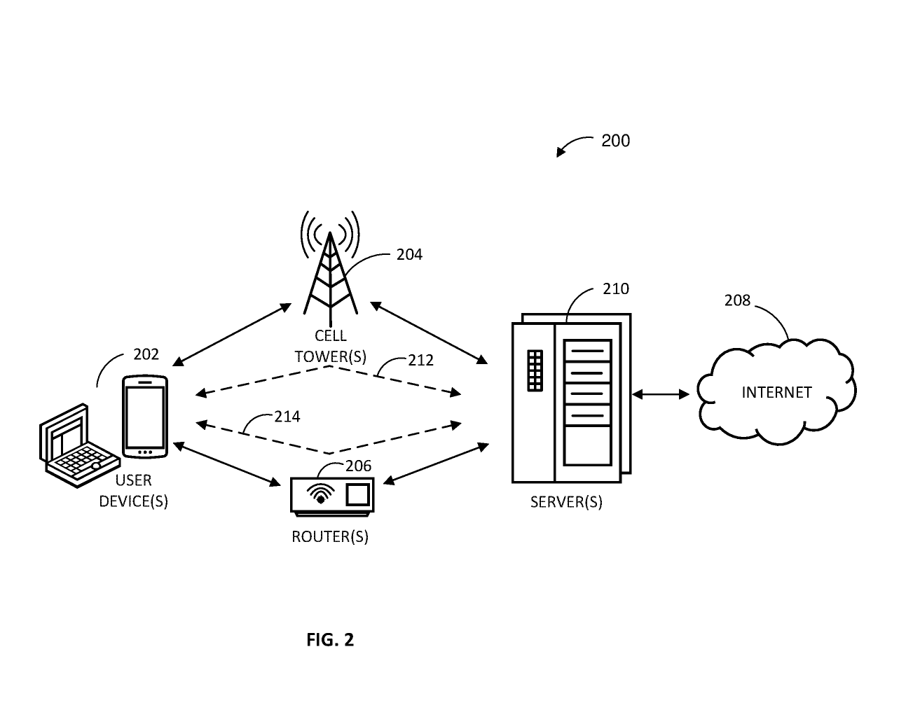

Embodiments are now described with reference to FIGS. 2-8, where like reference numbers may indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that the concepts described herein may also be employed in a variety of other systems and applications other than what is described herein.

FIG. 2 is a block diagram of an example network security and access control system 200, according to an embodiment. In system 200, all network traffic between one or more user devices 202 and the Internet 208 may be directed through one or more network security and access control servers 210 over one or more networks. Communications between user devices 202 and servers 210 may be via a protected communication layer 212/214 (e.g., a virtual private network (VPN) using any data communication means, including but not limited to, cellular communications through one or more cell towers 204, communications through one or more routers 206, etc. Other communication means may be contemplated as would be understood by those skilled in the relevant art.

Network security and access control server(s) 210 may include, or have access to, one or more data stores (not shown) that may store, for example, security- and access-related information, including security and access rules, account holder account data, account holder preference data, user data, user device data, etc. The data store(s) may be located within network security and access control server(s) 210 or external to (though accessible by) network security and access control server(s) 210. Network security and access control server(s) 210 may have direct access to the data store(s), or may access the data store(s) indirectly via one or more networks. In embodiments, the data store(s) may include a single storage device or multiple storage devices. In an embodiment, the data store(s) may include multiple storage devices distributed over one or more networks.

Network security and access control server(s) 210 may include a network security and access control manager (not shown) that may be implemented in software and/or hardware executed or controlled by one or more controllers or processors of network security and access control server(s) 210. While only one network security and access control server is illustrated for clarity and ease of discussion, it should be appreciated that the network security and access control server may include multiple distributed server computers for redundancy and/or load sharing, for example.

Network security and access control server(s) 210 may be, but are not to be limited to, for example, a remote service-provided access point (e.g., a publicly accessible server hosted by the service), part of a full-service configuration provided at a client location (e.g., a company, organization, educational institution, or government unit may host their own server(s) 210), part of a client's home network (e.g., a homeowner hosts own server(s)), etc. These implementations are by way of example. Other implementations may be contemplated, as would be understood by those of ordinary skill in the art.

User devices 202 may be computing devices that may include mobile and/or non-mobile devices. Mobile devices may include, but are not to be limited to, for example, laptop computers, ultra-laptop computers, tablets, touch pads, portable computers, handheld computers, wearable computers/technology, palmtop computers, personal digital assistants (PDAs), e-readers, cellular telephones, combination cellular telephone/PDAs, mobile smart devices (e.g., smart phones, smart tablets, etc.), mobile Internet devices (MIDs), mobile messaging devices, mobile data communication devices, mobile media playing devices, cameras, mobile gaming consoles, etc. Non-mobile devices may include, but are not to be limited to, for example, personal computers (PCs), televisions, smart televisions, data communication devices, media playing devices, gaming consoles, etc. Routers may also be user devices. User devices 202 may include controllers (or processors) and other components that execute software and/or control hardware to execute local programs or consume services provided by external service providers over a network (e.g., over the Internet). For example, user devices 202 may include one or more software clients or applications that run locally and/or utilize or access websites and/or web-based services (e.g., online stores or services, social networking services, etc.). User devices 202 may also, or instead, include a web interface running in a browser from which the user device can access such websites and/or web-based services. User devices 202 may also include storage devices (not shown) to store logic and data associated with the programs and services used by the users of the user devices.

As implementation of the network security and access control system may be cloud-based, in embodiments, the network security and access control system may be implemented similar to a peer-to-peer system where a network security and access control server 210 may also be a user device 202. In embodiments, a network security and access control server 210 may be user device 202 for which applications are being managed, or may be another user device 202. In other embodiments, network security and access control server 210 may be a dedicated server or group of servers.

The network or networks on which user devices 202 and network security and access control server(s) 210 reside may include any wired or wireless network, such as a Wide Area Network (WAN), a Local Area Network (LAN), and/or the like. As an example, the network(s) may include a distributed public network (e.g., as part of the Internet). Network security and access control server(s) 210 and user devices 202 may be connected to the network(s) via wired or wireless connections.

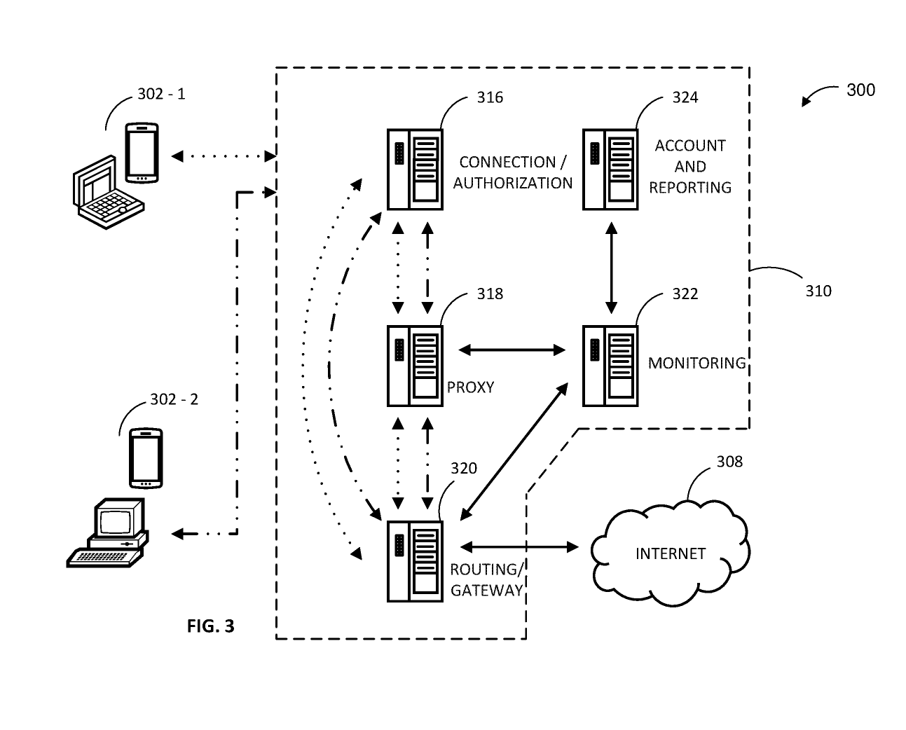

FIG. 3 is a more detailed block diagram of an example network security and access control system 300, showing example functional units of network security and access control server(s) 310, according to an embodiment. In system 300, one or more user devices may communicate with the Internet 308 through network security and access control server(s) 310. In the example shown in FIG. 3, a first user's devices 302-1 may include a mobile phone and/or a laptop, and a second user's devices 302-2 may include a mobile phone and/or a desktop computer. Network security and access control server(s) 310 may include, for example, a connection/authentication functional unit 316, a proxy functional unit 318, a routing/gateway functional unit 320, a monitoring functional unit 322, and an account and reporting functional unit 324. Functional units 316, 318, 320, 322, and 324 may all be a part of a single server device or may be distributed across multiple server devices. Similarly, each individual functional unit 316, 318, 320, 322, and 324 may exist on a single server device or may be distributed across multiple server devices. A more detailed discussion of the functionalities of each functional unit 316, 318, 320, 322, and 324 follows.

A person may become an account holder (e.g., an admin in an organization or corporate setting, a parent, etc.) of the network security and access control service by registering for the service through, for example, client software that is downloaded and run on a user device 302 or a web-based client running in a browser on a user device 302. When an account holder registers, aside from potentially providing identification and contact information, an account holder may be asked to establish one or more profiles and/or preferences with regard to one or more users and/or user devices. For example, an account holder may provide information on various users and associated user devices for which the account holder wants to monitor network traffic. The user information may include, but is not to be limited to, for example, user identification information, user device identification information, user device type information, operating system information, browser information, email and/or messaging information, application information, etc..

A client application may be downloaded and installed on each user device to be monitored (e.g., via standard downloading, via a bar or QR code, etc.). There may be different applications for different devices. For each user and/or user device to be monitored, the account holder may provide rules and/or preferences specific to the user and/or the user device (e.g., limitations or rules regarding HTTP/HTTPS traffic, emails, messages, etc.).

The account holder may provide settings and/or preferences regarding alerts and/or reports to be generated and/or provided to the account holder. Rules may be set or acquired in various ways. For example, in an embodiment, rule options may be presented to an account holder from which to choose. In an embodiment, rules may be downloaded from one or more of file(s), database(s), or external sources (e.g., a publically available blacklist or whitelist). In embodiments, file(s) and/or database(s) may be maintained by the service, while obtaining rules from external sources may require a subscription. The rules, settings and/or preferences may be per user, per device, or per account (i.e., across all of the users/devices that are set up through that account).

In an embodiment, rules may be hierarchical. For example, in a corporate setting, there may be a general policy, or set of rules, at a corporate-wide level, but there may be subsets of further rules for sub-groups of the organization (e.g., business units, departments, etc.). As another example, in a school setting, there may be a general policy, or set of rules, at a school-wide level, but there may be subsets of further rules by class (e.g., that may be customizable by each teacher). In such an example, the rules currently in place may change as a student changes classes (e.g., via schedule, via location of the user device or proximity of the user device to a location, via near field communication (e.g., Bluetooth), automatic check-in by the user device (e.g., via a tag on the device), manually (e.g., by the teacher), etc.).

In an embodiment, rules used or set by one account environment may be accessed and used by another. For example, a parent account holder may be able to access and activate rules provided by his or her child's school or class to be used during homework time at home. In such an embodiment, the parent account holder may be asked while setting up preferences and account settings whether a child's school is a user of the service. If so, a school provided code may be obtained by the parent and used to access the rules set up by the school or teacher.

In a hierarchical environment, there may be a main account holder, but may be further designated admins (e.g., business unit or department managers, teachers, etc.) that may have authorization to set further rules within their hierarchical levels. In an embodiment, rules may be pre-set but customizable. For example, there may be categorical pre-set rules from which an account holder may choose (e.g., by topic, by age, by port, etc.). In another example, an account, user, or device may be set up to have all network traffic blocked, but with exceptions customizable. In yet another example, rules may be set to notify of network traffic, but not block, filter, and/or modify network traffic. All of the registration information, rules, settings, preferences, etc., may be considered account profile information that may be stored at an account holder's user device 302, at network security and access control server(s) 310, or both.

Storage of the account profile information at the network security and access control server(s) 310 may depend on whether the user authorized such external storage of certain information personal to the user. In an embodiment, account profile information provided to the network security and access control server(s) 310 may be encrypted.

In an embodiment, an account holder may opt to use recommended rules/settings and/or a recommended profile (e.g., default settings and/or profile) instead of having to create one. A default profile may, for example, be based on community-based information and/or preferences of other account holders of the network security and access control service. An account profile may be edited by the account holder. In an embodiment, a graphical user interface on a user device of the account holder may allow an account holder to manage one or more of, for example, network traffic based rules, alerts, user accounts, user devices, report generation, etc. In embodiments, this account management may be performed from an application running on a user device of an account holder, from a website accessed on a user device of an account holder, etc. For example, to manage controlled devices, one or more user accounts may be accessed by an authorized account holder via the Internet from any network connected device. In an embodiment, a non-graphical interface such as an Application Program Interface (API) may be supported where other programs may communicate with the server logic of a network security and access control server via network commands, for example. An embodiment such as this may be used in a corporate environment, for example.

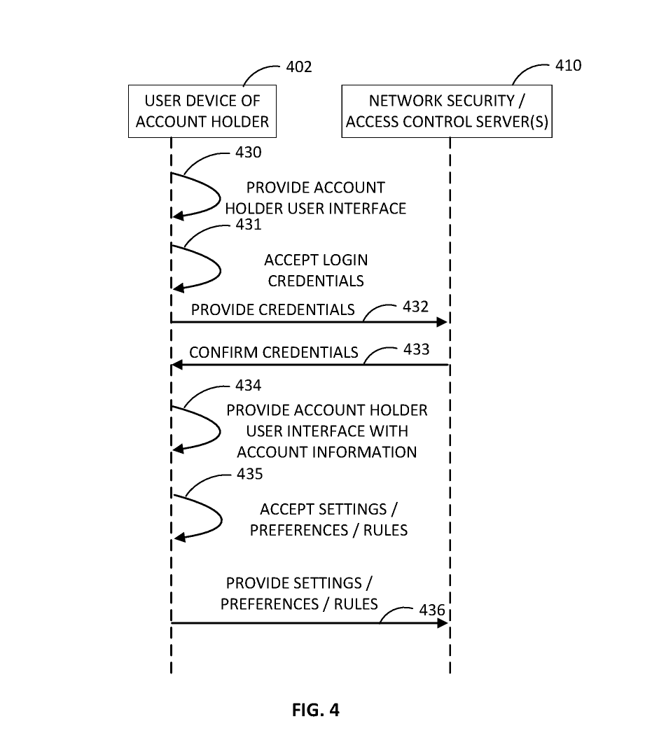

FIG. 4 is a sequence diagram showing an example account setup process, according to an embodiment. At 430, a user device 402 of an account holder provides an account holder user interface for logging into the service. At 431, user device 402 accepts login credentials entered by the account holder, and at 432, the entered credentials are provided to network security and access control server(s) 410 for confirmation of a valid account. At 433, network security and access control server(s) 410 send confirmation of the account to user device 402. At 434, user device 402 provides an account holder user interface with current account information (current settings, preferences, etc.). At 435, user device 402 accepts settings, preferences, rules, etc., entered by the account holder, and at 436, the entered information is provided to network security and access control server(s) 410.

In order to be monitored, a registered user device needs to establish a connection to the service. In an embodiment, an application may need to be installed on the user device. Network routers may also be configured to connect to the service. A user device (or router) may automatically connect to the service when network traffic is detected (e.g., by the installed application on the user device or router).

Referring back to FIG. 3, connection/authentication functional unit 316 may handle user device connection and authentication. A connection may be, but is not to be limited to, one or more of, a secure direct connection, an unsecure direct connection, a wired connection, a wireless connection, a cellular connection (e.g., 2G, 3G, 4G, 4G/LTE, etc.), a WiMax connection, a Wi-Fi connection, tunneled VPN, a proxy connection, a Bluetooth connection, etc. The “login” from a connected user device may be password-based. However, a user may not need to enter a password every time. For example, an account holder, who is a parent, may have set up (registered) user devices for his or her children to use. The parent may have used a password for the initial connection of a user device that a child may use. However, connection of that user device may be set up to be automatic for future connections to the service. The “login” from a connected user device may be certificate-based. Other login methods may also be contemplated, as would be understood by those of ordinary skill in the relevant arts.

Network traffic into the service may be encrypted and/or compressed, which may be configurable in the account profile information. A virtual interface for each user may be created, with network traffic being forwarded to proxy functional unit 318 and/or to router functional unit 320, for example. Network traffic may become unencrypted at this point. The virtual interface may be transparent to the user.

Proxy functional unit 318 may keep and/or enforce rules that were set upon registration with the service. Proxy functional unit 318 may enforce set limitations, or rules, for HTTP/HTTPS network traffic, emails, messages, etc.

Network traffic rules may include or involve one or more of, for example, Uniform Resource Locators (URLs), Internet Protocol (IP) addresses, ports (e.g., Transmission Control Protocol/User Datagram Protocol (TCP/UDP)), keywords (e.g., for searches, returned results, returned content, content being sent out (e.g., in emails, messages, files, documents, etc.), plain URLs, etc.), applications, bandwidth usage, physical location of user device, proximity of user device to a location, all network and/or Internet activity, content whitelists/blacklists (e.g., URLs, IP/ports, categories (e.g., groups of URLs, such as pornography, violence, social media, etc.) etc., to be allowed / not allowed), time of day, day of week, holiday status, etc.

For example, the rules may include, but are not to be limited to, for example, forbidden websites/domains to block, forbidden senders of email or other messages to block, websites/domains to be restricted (e.g., restricted to certain times of day or certain days of the week), content to be removed, filtered, or replaced (e.g., profane words or expletives, inappropriate content for children, proprietary and/or confidential information/documents, etc.), parts of websites, emails, messages, etc., to remove or modify (e.g., questionable or inappropriate videos, images, text, etc.). These rules are representative examples. Other rules or limitations may be contemplated, as would be understood by those of ordinary skill in the relevant arts. In embodiments, any rule may be enforced at specified times of the day.

Routing/gateway functional unit 320 may keep and/or enforce rules for network traffic other than that described above (e.g., gaming traffic, file sharing, etc.). For example, specific connections may be blocked based on the set rules, such as IP address origins and/or destinations (e.g., communications with certain organizations, countries, etc., may be blacklisted or blocked). Connections may be blocked at certain times of the day (e.g., if you do not want your child playing computer games, chatting, or browsing the Internet after 9 pm). Routing/gateway functional unit 320 may be used to block all network traffic, which may be more practical than having proxy functional unit 318 attempt to do so. The routing function may use Network Address Translation (NAT) rules to combine separate per-user virtual interfaces into one outbound connection to the Internet.

To enforce set rules, filtering logic may be used to direct or restrict network traffic. The filtering logic that may be used to enforce the set rules may be implemented by, but not limited to, for example, proxies, secure network connections (e.g., VPN), IP tables (e.g., via a router), interception of key words, etc. Detected rule violations may trigger further actions. A rule violation may be defined as a situation, or as network data, that matches the set rules as defined.

One or more alerts regarding a detected rule violation may be provided to a user of a user device to or from which a rule violation was detected and/or to the account holder (e.g., at, or accessible by, a user device of the account holder). An alert may include, but is not to be limited to, one or more of, an email-based alert, a text message-based alert, an application-based alert, a telephone call alert, a report, etc. How, when and to whom (or to what device) the alert is provided may be designated by the account holder in the account profile, for example.

Monitoring functional unit 322 may collect data, provide alerts, and/or generate reports on network (e.g., Internet) usage for an account holder and/or users. The reports may be per user, per device, per account, etc. The reports may be provided to the account holder (e.g., via an email or message, via telephone, via hardcopy mailing, etc.), by account and reporting functional unit 324 for example, and/or may be made available for download from the service (e.g., via account and reporting functional unit 324) when, for example, the account holder is logged into his or her account.

The alerts and/or reports may include information such as detected rule violations; information or warnings regarding network/Internet speed, availability, etc.; notice of connection and/or disconnection of a user device from the service; etc.

Other examples of statistics that may be collected and/or reported on may include, for example, total bandwidth usage, total bandwidth remaining, application bandwidth usage, application bandwidth remaining, network traffic statistics (e.g., where is the network traffic to/from (websites, email recipients/senders, etc.), network protocol statistics (e.g., whether encrypted connection, what protocols used, etc.), geo-based statistics (e.g., where the user devices were when used, geo-masking information, etc.), user device-based statistics, user-based statistics, etc.

Additional statistics that may be monitored and/or determined may include, for example, call record information, short message service (SMS) information and content (e.g., text-related information), application information (e.g., install/deletion actions, social media comments and/or image posts, etc.), cellular data usage, wireless data usage, access point information, etc.

As stated above, it may be determined that a user device has been disconnected from the network security and access control server(s). This determination may include one or more of, for example, detecting that the connection client application at the user device is no longer running, detecting software application changes at the user device (which may be device-specific) (e.g., closing or uninstalling a client application), etc.

Incremental heartbeats with a user device may also be monitored, where changes or lack of responses to communication attempts with the user device may signify that the user device has been disconnected from the service.

An account holder device and/or user device may be sent one or more alerts reporting that a user device has been disconnected from the service. The alerts may include, but are not to be limited to, one or more of, an email-based alert, a text message-based alert, an application-based alert, a telephone call alert, a report, etc., sent to, or accessible by a user device of the account holder and/or the user. How, when, and to whom (or to what device) the alert is provided may be designated by the account holder in the account profile, for example.

In embodiments, both incoming and outgoing network traffic (e.g., website requests, Internet searches, incoming/outgoing emails and messages, etc.) may be sent through the routing/gateway, proxy, monitoring, and/or connection/authentication functional units for monitoring, filtering, and/or modifying data as needed.

In embodiments, network traffic may enter network security and access control server(s) 310 at any one or more of connection/authentication functional unit 316, proxy functional unit 318, routing functional unit 320, monitoring functional unit 322, or account and reporting functional unit 324.

FIG. 3 depicts an embodiment that includes both proxy functional unit 318 and routing/gateway functional unit 320. As shown in FIG. 3, network traffic that has entered the system may be processed by both proxy functional unit 318 and routing/gateway functional unit 320, or may bypass proxy functional unit 318 to be processed by routing/gateway functional unit 320. This disclosure is not to be limited to this embodiment, however. Other embodiments may include a proxy functional unit 318 with no routing/gateway functional unit 320, or may include a routing/gateway functional unit 320 with no proxy functional unit 318. Furthermore, in embodiments, any one or more of the rules stated above as being kept and/or enforced by the proxy functional unit 318 or routing/gateway functional unit 320 may be kept and/or enforced by the proxy functional unit 318, the routing/gateway functional unit 320, or both.

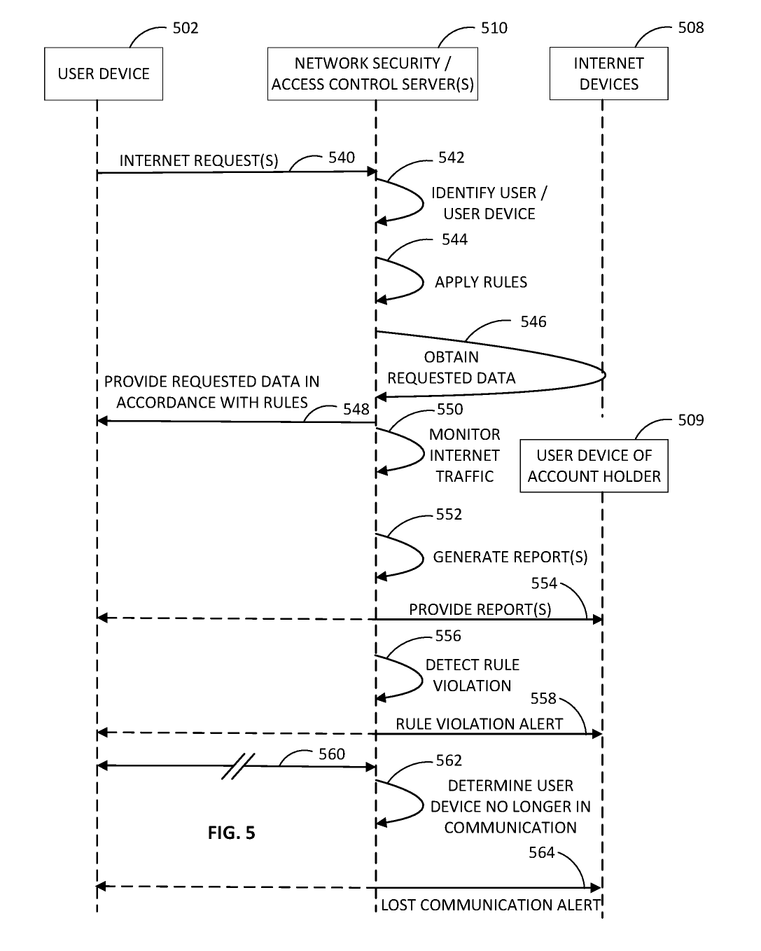

FIG. 5 is a sequence diagram showing example functionality of a network security and access control system, according to an embodiment. A user device 502 connected to network security and access control server(s) 510 may send out an Internet request (540) (e.g., a request to browse a website, the sending of an email, etc.). The Internet request may be received by network security and access control server(s) 510, and the user device and/or user making the Internet request may be identified (542).

For user devices that may be used by multiple users, the user may be determined based on login information used to access the device or one or more applications on the device, or other known ways to identify a user of a user device.

Rules set for the user and/or user device may be applied to the Internet request (544) by the network security and access control server(s) 510. For example, a URL of a website may be checked to make sure that it is not a forbidden website according to the set rules. As another example, an outgoing email may be checked to ensure that the email address or domain of the recipient is an allowed address or domain, according to the rules. In another example, an outgoing email may be checked to ensure the content provided in it is appropriate according to the rules (e.g., does not contain personal information (such as social security numbers or other information of a personal nature), does not contain profane language or other inappropriate content, such as inappropriate language, photos, or videos, etc.).

If the Internet request is an email, for example, and is in compliance with the set rules, it may be sent. If the Internet request is another type of Internet request (e.g., a website request or a search), and is in compliance with the set rules, the requested data (e.g., website, search results, etc.) may be obtained (546) from the Internet 508. The obtained requested data, or any incoming network traffic (e.g., an incoming email or message) may also have the set rules applied before being provided to user device 502 (548) by network security and access control server(s) 510 in accordance with those rules.

Any of actions 540 through 548 may be repeated with each Internet request and/or any incoming/outgoing network traffic.

All network traffic may be monitored (550) by network security and access control server(s) 510 in this way. Data regarding the monitored network traffic may be collected, and one or more reports regarding the monitored network traffic may be generated (552) by the network security and access control server(s) 510. The generated reports may be provided (554) by network security and access control server(s) 510 to, for example, a user device 509 of an account holder and/or the user device 502.

The reports may be provided via any of various formats (e.g., an email, a text message, an application message, a telephone call, a report document, etc.), and may be provided by request or automatically (e.g., when triggered by an event (e.g., reaching a threshold of rule violations, etc.), at regular intervals such as daily, weekly, or monthly, etc.). The reports may be per user, per device, per account, etc. How, when, and to whom reports are generated and provided may be set by the account holder in an account profile.

Network security and access control server(s) 510 may detect rules violations (556) regarding incoming and outgoing network traffic of connected user devices such as user device 502. Upon detection of a rule violation, a rule violation alert may be provided (558) by network security and access control server(s) 510 to, for example, user device 509 of the account holder and/or the user device 502. The rule violation alerts may be in any of various formats (e.g., an email, a text message, an application message, a telephone call, a report document, etc.). How, when, and to whom (or to what device) rule violation alerts are provided may be set by the account holder in an account profile.

If a user device 502 becomes disconnected (560) from network security and access control server(s) 510, network security and access control server(s) 510 may determine that the user device 502 is no longer in communication (562). For example, it may be detected that the connection client application at the user device is no longer running, or that the client application was closed or uninstalled at the user device 502. Incremental heartbeats with a user device may also be monitored, where changes or lack of responses to communication attempts with the user device may signify that the user device has been disconnected from the service. Upon determination that user device 502 has become disconnected from the service, a lost communication alert may be provided (564) by network security and access control server(s) 510 to, for example, user device 509 of the account holder and/or the user device 502. The lost communication alerts may be in any of various formats (e.g., an email, a text message, an application message, a telephone call, a report document, etc.). How, when, and to whom (or to what device) lost communication alerts are provided may be set by the account holder in an account profile.

One or more features disclosed herein may be implemented in hardware, software, firmware, and/or combinations thereof, including discrete and integrated circuit logic, application specific integrated circuit (ASIC) logic, and microcontrollers, and may be implemented as part of a domain-specific integrated circuit package, or a combination of integrated circuit packages. The terms software and firmware, as used herein, refer to a computer program product including at least one computer readable medium having computer program logic, such as computer-executable instructions, stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, SRAM, DRAM, a hard drive, a solid state drive, or other data storage device.

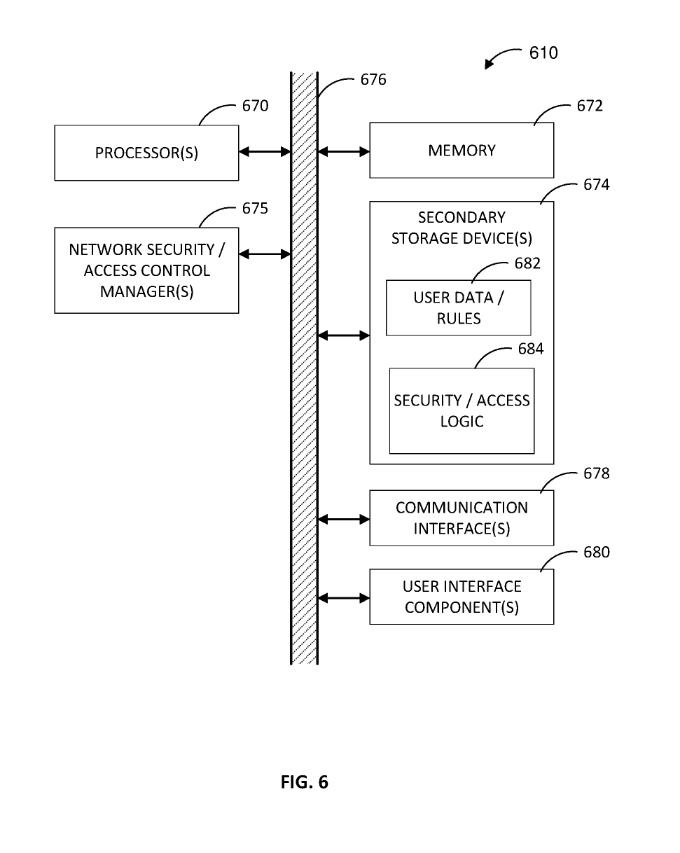

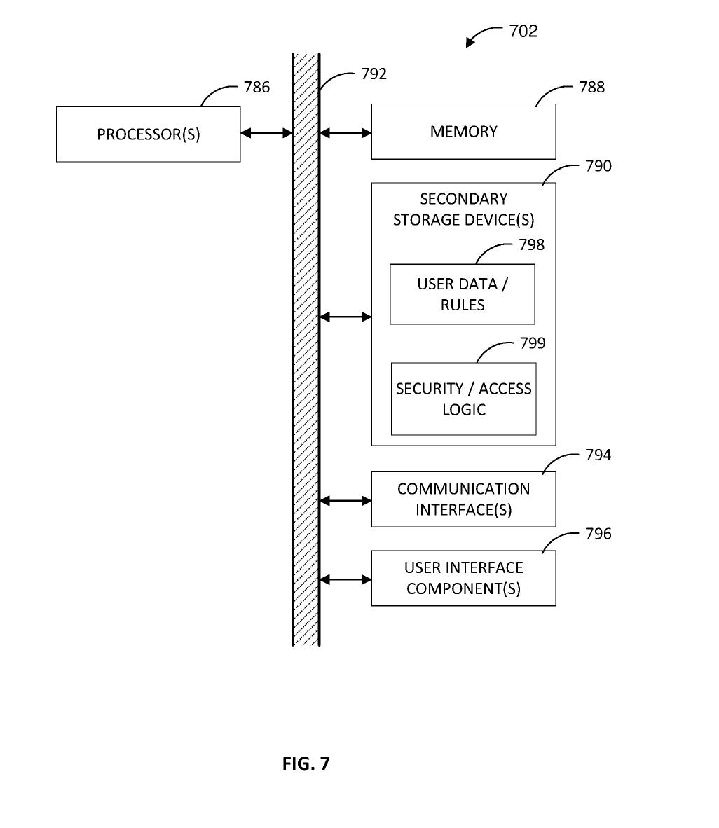

As stated above, in embodiments, some or all of the processing described herein may be implemented as hardware, software, and/or firmware. Such embodiments may be illustrated in the context of example computing systems 610 and 702 as shown in FIGS. 6 and 7. Computing system 610 shows an implementation of network security and access control server(s) 210/310/410/510 according to an embodiment, and computing system 702 shows an implementation of a user device 202/302/402/502/509, according to an embodiment.

Computing system 610 may include one or more central processing unit(s) (CPU), such as one or more general processors 670, connected to memory 672, one or more secondary storage devices 674, and one or more network security and access managers 675 by a link 676 or similar mechanism. In an embodiment, network security and access manager(s) 675 may be processors dedicated to network security and access control by server(s) of a network security and access control service as described herein. In an embodiment, network security and access control manager(s) 675 may be integrated with general processor(s) 670. The general processor(s) 670 and/or network security and access control manager(s) 675 may include one or more logic units for carrying out the methods described herein. In embodiments, other logic units may also be present. One of ordinary skill in the art would recognize that the functions of the logic units may be executed by a single logic unit, or any number of logic units.

Computing system 610 may optionally include communication interface(s) 678 and/or user interface components 680. The communication interface(s) 678 may be implemented in hardware or a combination of hardware and software, and may provide a wired or wireless network interface to a network, such as the network(s) shown in FIGS. 2 and 3. The user interface components 680 may include, for example, a touchscreen, a display, one or more user input components (e.g., a keyboard, a mouse, etc.), a speaker, or the like, or any combination thereof.

The one or more secondary storage devices 674 may be, for example, one or more hard drives or the like, and may store account holder, user, and/or rule data 682 (e.g., account holder data, account holder preference information, user information, user preferences, user device information, security and/or control rules, etc.) and logic 684 (e.g., security and/or access logic) to be executed by one or more general processor(s) 670 and/or network security and access control manager(s) 675.

In an embodiment, general processor(s) 670 and/or network security and access control manager(s) 675 may be microprocessors, and logic 684 may be stored or loaded into memory 672 for execution by general processor(s) 670 and/or network security and access control manager(s) 675 to provide the functions described herein. Note that while not shown, computing system 610 may include additional components.

Computing system 702 may include one or more central processing unit(s) (CPU), such as one or more general processors 786, connected to memory 788 and one or more secondary storage devices 790 by a link 792 or similar mechanism. The general processor(s) 786 may include one or more logic units for carrying out the methods described herein. In embodiments, other logic units may also be present. One of ordinary skill in the art would recognize that the functions of the logic units may be executed by a single logic unit, or any number of logic units.

Computing system 702 may optionally include communication interface(s) 794 and/or user interface components 796. The communication interface(s) 794 may be implemented in hardware or a combination of hardware and software, and may provide a wired or wireless network interface to a network, such as the network(s) shown in FIGS. 2 and 3. The user interface components 796 may include, for example, a touchscreen, a display, one or more user input components (e.g., a keyboard, a mouse, etc.), a speaker, or the like, or any combination thereof.

The one or more secondary storage devices 790 may be, for example, one or more hard drives or the like, and may store user and/or rule data 798 (e.g., user information, user preferences, user device information, security and/or control rules, etc.) and logic 799 (e.g., security and/or access logic) to be executed by one or more general processor(s) 786. In an embodiment, general processor(s) 786 may be microprocessors, and logic 799 may be stored or loaded into memory 788 for execution by general processor(s) 786 to provide the functions described herein. Note that while not shown, computing system 702 may include additional components.

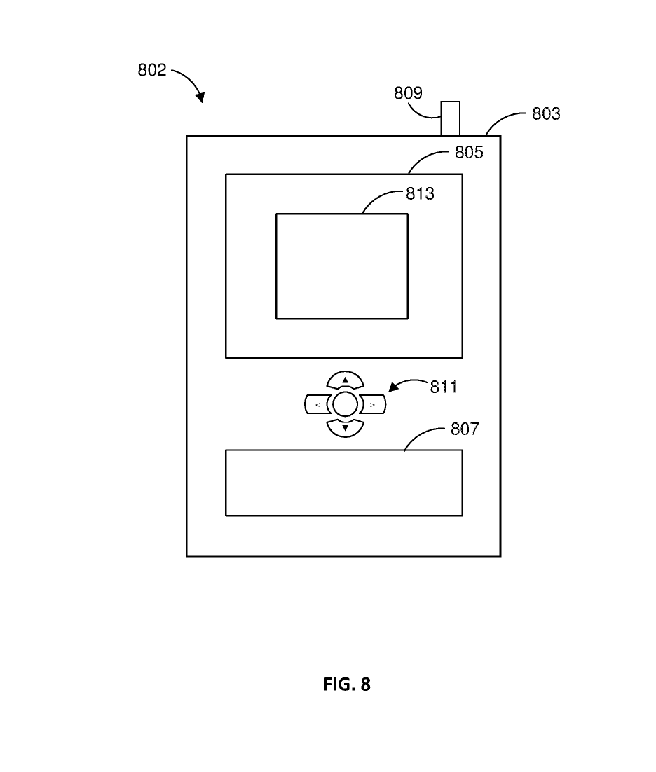

Computing system 702 may be implemented in varying physical forms. FIG. 8 illustrates embodiments of an example device 802 in which system 702 may be embodied. In embodiments, for example, device 802 may be implemented as a mobile computing device having a processing system, a mobile power source (e.g., a battery), and wireless capabilities.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile Internet device (MID), messaging device, data communication device, etc.

Examples of a mobile computing device also may include computers that may be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 8, device 802 may include a housing 803, a display 805, an input/output (I/O) device(s) 807, and an antenna 809. Device 802 also may include navigation features 811. Display 805 may include any suitable display unit for displaying information 813 appropriate for a mobile computing device. I/O device(s) 807 may include any suitable I/O device for entering information into a mobile computing device. Examples of I/O device(s) 807 may include an alphanumeric keyboard, a numeric keypad, a touch pad, input keys, buttons, switches, rocker switches, microphones, speakers, voice recognition devices and software, etc. Information entered by way of microphone may be digitized by a voice recognition device. The embodiments are not to be limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate arrays (FPGA), logic gates, registers, semiconductor devices, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations may be stored on a tangible, machine readable medium and supplied to various customers or manufacturing facilities to load into the fabrication machines that make the logic or processor.

Technologies disclosed herein may provide a cloud-based network security and access control service. Using this service, security may be moved away from individual user devices and on to one or more centralized devices, or servers. The centralized devices, or servers, may apply rules to, for example, alert on, block, capture, process, redirect, and/or report on a connected user device's incoming and outgoing network traffic. Other features, such as reporting on application status, tampering, mobile phone usage, etc., may also be implemented.

There are many advantages to the described service. One advantage includes centralized account administration that is not dependent on where the admin (account holder) is, where the user devices to be monitored are, what operating systems are used on the user devices, or how the user devices are connected to the service. In addition, it is not necessary to individually update security and/or access rules on each user device, and there is no need to root or “jail-break” individual user devices in order to provide the desired network security and access control. Another advantage includes the optional use of a secure VPN connection to the service server(s). Encryption may be used for privacy. Further security is also provided in implementations where the server(s) are located at the client/customer site (e.g., home, business, etc.). A further advantage includes preventing an Internet Service Provider (ISP) from examining network traffic (due to its encryption, for example). Many other advantages may also be contemplated.

The particular examples and scenarios used in this document are for ease of understanding and are not to be limiting. Although the examples used herein are directed to home (e.g., family), corporate, or school implementations, other scenarios may be contemplated. For example, hotels that want to use different pricing models can use this technology to maximize profits per bandwidth (e.g., they could charge more money to stream movies and music while blocking customers who did not pay for that extended service. In another example, the technologies described herein may be useful for enforcing a commercial or corporate “bring-your-own-device” policy, where the application running on employee-owned devices can enforce the employer's policy during work hours. The technologies described herein may also be used to protect privacy while using public or other Wi-Fi communications. For example, a coffee shop could be stopped from targeting a customer using the shop's Wi-Fi with specific ads based on the customer's set browsing profile and/or device location. Moreover, features described herein may be used in many other contexts, as would be understood by one of ordinary skill in the art.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons of ordinary skill in the relevant art that various changes in form and detail may be made therein without departing from the scope of the methods and systems disclosed herein. Thus, the breadth and scope of the claims should not be limited by any of the exemplary embodiments disclosed herein.

As used in this application and in the claims, a list of items joined by the term “one or more of can mean any combination of the listed terms. For example, the phrases “one or more of A, B or C” and “one or more of A, B, and C” can mean A; B; C; A and B; A and C; B and C; or A, B and C.

What is claimed is:

1. A method of controlling access to a communication network, comprising:
configuring an organization network access policy based on input of a manager of the organization;
configuring a sub-group network access policy for each of multiple sub-groups based on input of managers of the respective sub-groups;
associating each of multiple users of the organization, and communication devices of the respective users, with one or more of the sub-groups of the organization;
intercepting network access requests at a gateway to the network;
identifying intercepted network access requests of communication devices of the users amongst the intercepted network access requests; and
processing the intercepted network access requests of the communication devices of the users based on the organization network access policy and the sub-group network access policies of the sub-groups associated with the respective users.

2. The method of claim 1, wherein the organization includes an educational institution, the users include students of the educational institution, the managers of the sub-groups include teachers of the educational institution, and the sub-groups of the organization include teacher-based groups, and wherein:
the associating includes associating a communication device of each of the students with one or more of the teacher-based groups;
the configuring a sub-group network access policy includes configuring a teacher-based network access policy for each of the teacher-based groups based on input of the respective teachers;
the configuring an organization network access policy includes configuring an educational institution network access policy based on input of a manager of the educational institution;
the intercepting includes intercepting network access requests that originate from communication devices within a facility of the educational institution; and
the processing includes processing intercepted network access requests of the communication devices of the students based on the respective associated teacher-based network access policies and the educational institution network access policy.

3. The method of claim 2, further including:
configuring a guardian-based network access policy for each of the students based on input of guardians of the respective students; and
associating the communication device of each of the students with a respective one of the guardian-based network access policies;
wherein the processing further includes processing the intercepted network access requests of the communication devices of the students based on the respective associated teacher-based network access policies, the respective associated guardian-based network access policies, and the educational institution network access policy.

4. The method of claim 1, wherein the organization includes a corporation, the users include employees of the corporation, the sub-groups of the organization include one or more of business units, divisions, departments, and facilities of the corporation, and the managers of the sub-groups include managers of the business units, divisions, departments, and/or facilities of the corporation, and wherein:
the associating includes associating a communication device of each of the employees with one or more of the business units, divisions, departments, and/or facilities of the corporation;
the configuring a sub-group network access policy includes configuring a local network access policy for each of the business units, divisions, departments, and/or facilities of the corporation based on input of the respective managers;
the configuring an organization network access policy includes configuring a corporate network access policy based on input of a corporate manager;
the intercepting includes intercepting network access requests that originate from communication devices within a facility of the corporation; and
the processing includes processing intercepted network access requests of the communication devices of the employees based on the respective associated local network access policies and the corporate network access policy.

5. The method of claim 1, wherein the intercepting includes one or more of:
intercepting network access requests that originate from communication devices within a facility of the organization; and
intercepting network access requests that pass through a wireless access point of the organization.

6. The method of claim 1, wherein the intercepting includes one or more of:
configuring a network router to direct network access requests to a network access control server, and performing the identifying and the processing at the network access control server;
hosting a virtual interface to the network for the communication devices of the users; and
providing the communication devices of the users with browser based virtual interfaces to the network.

7. The method of claim 1, wherein the intercepting is performed without necessitating loading a new computer program on the communication devices of the users.

8. The method of claim 1, wherein the processing includes:
forwarding an intercepted network access request of a communication device of a user if the network access request complies with the organization network access policy and the sub-group network access policy of one or more sub-groups associated with the user.
receiving a response to the network access request from the communication network; and
forwarding the response to the communication device of the user if the response complies with the organization network access policy and the sub-group network access policy of the one or more sub-groups associated with the user.

9. The method of claim 1, further including:
reporting to a manager of a sub-group if an intercepted network access request of a communication device associated with the sub-group does not comply with the network access policy of the sub-group.

10. The method of claim 1, wherein:
the intercepting includes establishing a communication session between a network access control server and each of the communication devices of the users; and
the processing includes reporting to a manager of a sub-group if a communication session between the network access control server and a communication device associated with the sub-group terminates.

11. The method of claim 1, further including:
dynamically re-associating a communication device of a user from a first sub-group to a second sub-group based on one or more of a schedule of the user and a physical location of the communication device of the user.

12. The method of claim 1, further including:
constructing network access rules for each of multiple categories of network access rules;
wherein the configuring a sub-group access policy includes permitting the manager of each sub-group to select one or more of the categories of network access rules through a computer-based user interface, and configuring the sub-group access policy of each sub-group to include the network access rules selected by the respective sub-group manager.

13. The method of claim 12, wherein:
the constructing includes constructing network access rules for each of multiple user age based categories; and
the configuring a sub-group access policy further includes permitting the manager of each sub-group to select one or more of the user age based categories of network access rules based on ages of users associated with the respective sub-groups.

14. The method of claim 12, wherein:
the constructing includes constructing network access rules for each of multiple subject matter based categories; and
the configuring a sub-group access policy further includes permitting the manager of each sub-group to select one or more of the subject matter based categories of network access rules.

15. The method of claim 12, wherein the configuring a sub-group access policy further includes:
permitting the manager of each sub-group to select one or more of the categories of network access rules through a browser based interface of a device of the manager, without necessitating loading a new computer program on the device of the manager.

16. A non-transitory computer readable medium encoded with a computer program that includes instructions to cause a processor to:
configure an organization network access policy based on input of a manager of the organization;
configure a sub-group network access policy for each of multiple sub-groups based on input of managers of the respective sub-groups;
associate each of multiple users of the organization, and communication devices of the respective users, with one or more of the sub-groups of the organization;
intercept network access requests at a gateway to the network;
identify intercepted network access requests of communication devices of the users amongst the intercepted network access requests; and
process the intercepted network access requests of the communication devices of the users based on the organization network access policy and the sub-group network access policies of the sub-groups associated with the respective users.

17. The non-transitory computer readable medium of claim 16, wherein the organization includes an educational institution, the users include students of the educational institution, the managers of the sub-groups include teachers of the educational institution, and the sub-groups of the organization include teacher-based groups, further including instructions to cause the processor to:
associate a communication device of each of the students with one or more of the teacher-based groups;
configure the sub-group network access network policy to include a teacher-based network access network access policy for each of the teacher-based groups based on input of the respective teachers;
configure the organization network access policy to include an educational institution network access policy based on input of a manager of the educational institution;
intercept network access requests that originate from communication devices within a facility of the educational institution; and
process the intercepted network access requests of the communication devices of the students based on the respective associated teacher-based network access policies and the educational institution network access policy.

18. The non-transitory computer readable medium of claim 17, further including instructions to cause the processor to:
configure a guardian-based network access policy for each of the students based on input of guardians of the respective students; and
associate the communication device of each of the students with a respective one of the guardian-based network access policies;
process the intercepted network access requests of the communication devices of the students based on the respective associated teacher-based network access policies, the respective associated guardian-based network access policies, and the educational institution network access policy.

19. The non-transitory computer readable medium of claim 16, wherein the organization includes a corporation, the users include employees of the corporation, the sub-groups of the organization include one or more of business units, divisions, departments, and facilities of the corporation, and the managers of the sub-groups include managers of the business units, divisions, departments, and/or facilities of the corporation, further including instructions to cause the processor to:
associate a communication device of each of the employees with one or more of the business units, divisions, departments, and/or facilities of the corporation;
configure the sub-group network access policy to include a local sub-group network access policy for each of the business units, divisions, departments, and/or facilities of the corporation based on input of the respective managers;
configure the organization network access policy to include a corporate network access policy based on input of a corporate manager;
intercept network access requests that originate from communication devices within a facility of the corporation; and
process intercepted network access requests of the communication devices of the employees based on the respective associated local network access policies and the corporate network access policy.

20. The non-transitory computer readable medium of claim 16, further including instructions to cause the processor to perform one or more of:
intercept network access requests that originate from communication devices within a facility of the organization; and
intercept network access requests that pass through a wireless access point of the organization.

21. The non-transitory computer readable medium of claim 16, further including instructions to cause the processor to perform one or more of:
configure a network router to direct network access requests to a network access control server, and performing the identifying and the processing at the network access control server;
host a virtual interface to the network for the communication devices of the users; and
provide the communication devices of the users with browser based virtual interfaces to the network.

22. The non-transitory computer readable medium of claim 16, further including instructions to cause the processor to intercept the network access requests without necessitating loading a new computer program on the communication devices of the users.

23. The non-transitory computer readable medium of claim 16, further including instructions to cause the processor to:
forward an intercepted network access request of a communication device of a user if the network access request complies with the organization network access policy and the sub-group network access policy of one or more sub-groups associated with the user.
receive a response to the network access request from the communication network; and
forward the response to the communication device of the user if the response complies with the organization network access policy and the sub-group network access policy of the one or more sub-groups associated with the user.

24. The non-transitory computer readable medium of claim 16, further including instructions to cause the processor to:
report to a manager of a sub-group if an intercepted network access request of a communication device associated with the sub-group does not comply with the network access policy of the sub-group.

25. The non-transitory computer readable medium of claim 16, further including instructions to cause the processor to:
establish a communication session between a network access control server and each of the communication devices of the users; and
report to a manager of a sub-group if a communication session between the network access control server and a communication device associated with the sub-group terminates.

26. The non-transitory computer readable medium of claim 16, further including instructions to cause the processor to:
dynamically re-associate a communication device of a user from a first sub-group to a second sub-group based on one or more of a schedule of the user and a physical location of the communication device of the user.

27. The non-transitory computer readable medium of claim 16, further including instructions to cause the processor to:
construct network access rules for each of multiple categories of network access rules;
permit the manager of each sub-group to select one or more of the categories of network access rules through a computer-based user interface, and configuring the sub-group access policy of each sub-group to include the network access rules selected by the respective sub-group manager.

28. The non-transitory computer readable medium of claim 27, further including instructions to cause the processor to:
construct network access rules for each of multiple user age based categories; and
permit the manager of each sub-group to select one or more of the user age based categories of network access rules based on ages of users associated with the respective sub-groups.

29. The non-transitory computer readable medium of claim 27, further including instructions to cause the processor to:
construct network access rules for each of multiple subject matter based categories; and
permit the manager of each sub-group to select one or more of the subject matter based categories of network access rules.

30. The non-transitory computer readable medium of claim 27, further including instructions to cause the processor to:
permit the manager of each sub-group to select one or more of the categories of network access rules through a browser based interface of a device of the manager, without necessitating loading a new computer program on the device of the manager.
